(19) United States
(12) Patent Application Publication
(10) Pub. No.: US 2025/0304461 A1
(43) Pub. Date: Oct. 2, 2025

(54) NANO-SIZED POLYHEDRAL a-ALUMINA PARTICLE AND METHOD FOR PRODUCING SAME

(71) Applicant: DAEHONG TECHNEW CO., LTD, Seoul (KR)

(72) Inventors: Jin Su LEE, Gyeonggi-do (KR); Jeonghwan KIM, Gyeonggi-do (KR); Dong Kyun KIM, Gyeonggi-do (KR); Jungseok KIM, Gyeonggi-do (KR)

(21) Appl. No.: 18/698,624

(22) PCT Filed: Oct. 28, 2022
(86) PCT No.: PCT/KR2022/016644

§ 371 Date: Apr. 4, 2024

(30) Foreign Application Priority Data
Oct. 28, 2021 (KR) 10-2021-0145651

(51) Int. Cl. C01F 7/441; C01F 7/023; C01F 7/34; C09D 1/00; H01M 50/434; H01M 50/446; H01M 50/449

(52) U.S. Cl. CPC C01F 7/441; C01F 7/023; C01F 7/34; C09D 1/00; H01M 50/434; H01M 50/446; H01M 50/449; C01P 2002/76; C01P 2002/77; C01P 2004/03; C01P 2004/04; C01P 2004/62

(57) ABSTRACT

The present invention provides a coating agent including α-alumina particles having a polyhedral crystal structure and having an average particle size (D50) of 100-900 nm. The α-alumina particles are produced in such a way that pseudo-boehmite is mixed with a fluoride-based mineralizer and ultrapure water and pulverized to obtain a powder which is then fired and grown into a polyhedral shape. The polyhedral alumina particles make surface contact and are coated on the surface of a porous polymer substrate, and empty space induced by the interstitial volume between particles is formed larger than that of spherical particles, thereby being capable of achieving excellent air permeability while effectively suppressing thermal contraction of the porous polymer substrate. In addition, due to a nano-level particle size, excellent dispersibility and the formation of a thin coating layer can be achieved.

### CROSS REFERENCE TO RELATED APPLICATIONS

The present application is a National Stage filing of PCT Application No. PCT/KR2022/016644 filed Oct. 28, 2022, entitled “Nano-Sized Polyhedral α-Alumina Particle And Method For Producing Same”, which claims the benefit of priority based on Korean Patent Application No. 10-2021-0145651 filed on Oct. 28, 2021.

### TECHNICAL FIELD

The present invention relates to nano-sized α-alumina particles that have a polyhedral crystal structure and can be usefully used as a coating composition for components such as secondary battery separators, and a method of producing same.

### BACKGROUND ART

Alumina (Al₂O₃) has excellent mechanical strength such as wear resistance, chemical stability, thermal conductivity, and heat resistance, and is used in a wide range of fields such as abrasives, electronic materials, heat dissipation fillers, optical materials, and biological materials. Such alumina includes α, γ or η crystalline alumina, amorphous alumina, etc., but generally refers to α-alumina, and its use may vary depending on particle size, shape, surface characteristics, and degree of aggregation.

Recently, alumina has been used as a surface coating to provide thermal stability to the separator of secondary batteries used in various electrical/electronic devices, including mobile devices and electric vehicles.

In secondary batteries, the separator functions to separate a positive electrode and a negative electrode to prevent electrical short-circuit and maintain high ionic conductivity by absorbing the electrolyte required for the battery reaction. For this purpose, it is generally made of a porous polymer substrate (e.g., polyolefin). Due to the porous polymer substrate's property of shrinking when heated, the positive electrode and the negative electrode may come into contact, resulting in safety problems such as fire and explosion. To overcome this problem, inorganic particles such as alumina are coated on one or both sides of the porous polymer substrate along with a binder to protect the separator from the risk of fracture and prevent heat shrinkage.

Alumina for such separator coatings is mostly used in the form of spherical or amorphous particles. As the spherical alumina is coated on the surface of the separator, an empty space is formed by the interstitial volume between particles, thereby maintaining the air permeability of the separator and enabling smooth movement of ions inside the battery. However, since the spherical alumina is coated with forming point contact on the surface of the separator, it has the disadvantage of being weak in suppressing shrinkage when the separator is deformed by heat (see FIG. 1). Additionally, amorphous particles have an irregular shape, increasing the possibility of causing coating defects on the surface of the separator.

Korean Patent Publication No. 10-2018-0010477 (Applicant: CIS Chemical Co., Ltd.) describes that in order to provide alumina for coating of secondary battery separators, micro-sized plate-like alumina is manufactured by mixing aluminum hydroxide, ammonium chloride, and sodium polyphosphate in a solvent, followed by high-temperature heat treatment, filtration and washing, and dry pulverization. This plate-like alumina is excellent at preventing shrinkage due to heat by making surface contact with the surface of the separator. However, since it is laminated in a plate shape by the surface contact on the surface of the separator, it can block the pores of the separator, which reduces ion movement and results in a decrease in battery performance (see FIG. 2).

### DETAILED DESCRIPTION OF THE INVENTION

### Technical Problem

The purpose of the present invention is to overcome the disadvantages of the prior art, and it is to provide a coating composition comprising α-alumina particles that can form surface contact on the surface of a porous substrate such as a secondary battery separator, thereby improving heat shrinkage resistance and realizing excellent air permeability, and a method for producing the same.

### Solution to Problem

One aspect of the present invention provides a coating composition comprising a-alumina particles having a polyhedral crystal structure and an average particle diameter (D₅₀) of 100 to 900 nm.

Another aspect of the present invention provides a method for producing α-alumina particles contained in the coating composition, the method comprising:
(S1) mixing and reacting an aqueous solution comprising one or more aluminum salts with an aqueous solution containing a pH adjusting agent, and filtering and washing the product to obtain pseudo-boehmite of the following structural formula 1;
(S2) mixing the pseudo-boehmite with a fluorine-based mineralizer and ultrapure water, and pulverizing the mixture, followed by filtering and drying; and
(S3) filtering and drying the product of step (S2) and then calcining it to obtain a powder of α-alumina particles having a polyhedral crystal structure and an average particle diameter (D₅₀) of 100 to 900 nm.

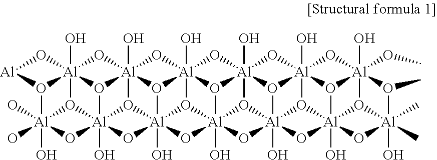

Another aspect of the present invention provides a component comprising a porous polymer substrate and a coating layer formed on one or both sides of the substrate, wherein the coating layer includes a coating composition comprising the nano-sized polyhedral α-alumina particles.

### Effect of the Invention

The present invention provides a coating composition comprising α-alumina particles having a polyhedral crystal structure and having an average particle size (D₅₀) of 100 to 900 nm. The α-alumina particles are produced in such a way that pseudo-boehmite is mixed with a fluoride-based mineralizer and ultrapure water and pulverized to obtain a powder which is then fired and grown into a polyhedral shape. The polyhedral alumina particles make surface contact and are coated on the surface of a porous polymer substrate, and empty space induced by the interstitial volume between particles is formed larger than that of spherical particles, thereby being capable of achieving excellent air permeability while effectively suppressing thermal contraction of the porous polymer substrate. In addition, due to a nano-level particle size, excellent dispersibility and the formation of a thin coating layer can be achieved.

### BRIEF DESCRIPTION OF DRAWINGS

FIGS. 1 to 3 each schematically illustrate the surface contact form when coating a substrate according to the shape of α-alumina particles.

FIG. 4 shows a scanning electron microscope (SEM) photograph and transmission microscope (TEM) photograph of polyhedral α-alumina particles prepared in Examples 1 and 2 and Comparative Example 1.

FIG. 5 shows an SEM photograph of plate-like α-alumina particles prepared in Comparative Example 2.

FIG. 6 shows the observed dimensional change due to heat shrinkage according to the size and type of coated alumina particles of the circular specimen in Experimental Example 2.

### BEST MODE FOR CARRYING OUT THE INVENTION

Since the present invention can be modified in various ways and can have various embodiments, specific embodiments will be illustrated in the drawings and described in detail in the detailed description. However, it is not intended to limit the present invention to specific embodiments, and should be understood to include all modifications, equivalents, and substitutes included in the spirit and scope of the present invention. In describing the present invention, if it is determined that a detailed description of a related known technology may obscure the gist of the present invention, the detailed description thereof will be omitted.

Hereinafter, the present invention will be described in more detail.

One embodiment of the present invention relates to a coating composition comprising nano-sized α-alumina particles having a polyhedral crystal structure.

The polyhedral crystal structure crystallographically means that it has about 1 of a ratio (D/H) of the diameter (D) perpendicular to the [0001] plane that is the C plane, and the height (H) parallel thereto.

In particular, the α-alumina particle according to the present invention may have a 14-hedral crystal structure in which the [0001] planes represent 10 to 20%, specifically to 20%, of the total crystal plane area in the polyhedral crystal structure. If the area of the [0001] planes is less than 10%, it has a rod shape, and if the area exceeds 20%, it has a shape close to a plate. Meanwhile, ‘amorphous’ refers to an irregular state in which the appearance is not uniform and is distinguished from the polyhedral crystal structure of the present invention with clear crystal planes.

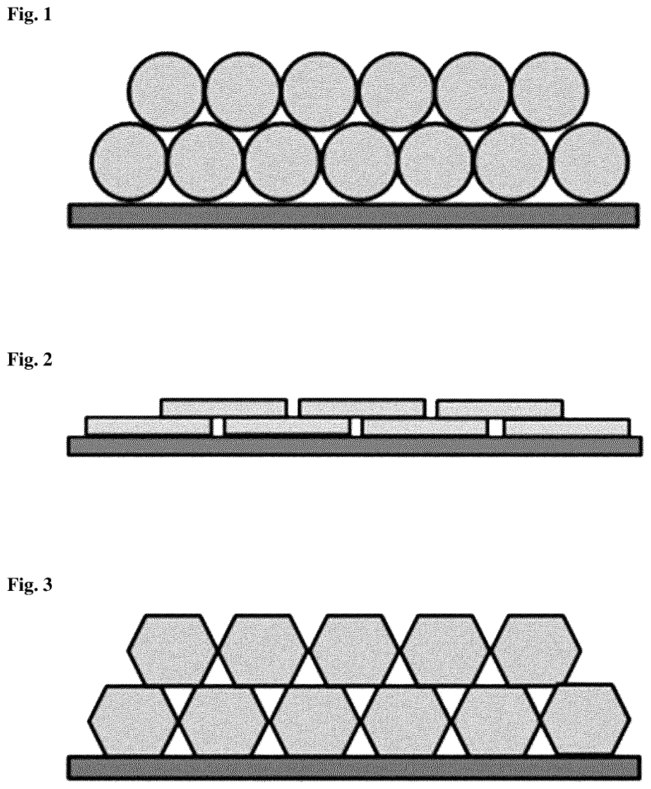

When the alumina particles having a polyhedral crystal structure of the present invention are coated on the surface of a porous substrate, the particles disperse and come into contact with each other, and an empty space is formed by a certain angle formed by meeting of polyhedron crystal planes. The empty space may be referred to as a pore formed by the interstitial volume between particles, and with comparing FIG. 1 and FIG. 3, the empty space formed by polyhedral particles is larger than the empty space formed by spherical particles.

Referring again to FIG. 3, since the particles of the polyhedral crystal structure form surface contact when coated on the surface of the substrate, the particles are more effective in preventing heat shrinkage of the substrate, compared to spherical particles (FIG. 1) that form point contact on the surface of the substrate.

Referring to FIG. 2, the plate-like particles form surface contact with the surface of the substrate, so they are excellent in preventing heat shrinkage of the substrate, but as the particles are stacked in a plate shape, the formation of empty spaces is small, which is disadvantageous in terms of air permeability.

Therefore, the α-alumina particles having a polyhedral crystal structure of the present invention can be usefully used as a coating composition that does not impair battery performance since they not only promote thermal stability by effectively suppressing heat shrinkage when coated on a porous polymer substrate such as a secondary battery separator, but also enable smooth movement of lithium ions to the porous substrate.

In addition, the α-alumina particles of the polyhedral crystal structure of the present invention are characterized by an average particle diameter (D₅₀) in the range of 100 to 900 nm, in particular 200 to 600 nm.

The D₅₀ represents the median value in the particle size distribution measured using a conventional method in the art, for example, a laser particle size analyzer. In the present invention, the α-alumina particles have a nano level of D₅₀, so they can improve the dispersion in the coating solution. It is advantageous in that it can reduce the weight and volume of the secondary battery to which the separator is applied, by forming a thin coating layer compared to micro-sized particles.

When the polyhedral α-alumina particles are coated on the surface of a porous substrate such as a separator, it is preferred that the average particle diameter of the alumina particles is selected to be larger than the pore size of the porous substrate to avoid particles filling the pores of the porous substrate.

Another embodiment of the present invention relates to a method of manufacturing an abrasive comprising the α-alumina particles of the polyhedral crystal structure. Hereinafter, the method will be described for each step.

First, an aqueous solution comprising one or more aluminum salts and an aqueous solution containing a pH adjusting agent are mixed and reacted (S1).

The aluminum salt may include aluminum sulfate (Al₂(SO₄)₃·4˜18H₂O), aluminum nitrate (Al(NO₃)₃·9H₂O), aluminum acetate (Al(CHCOO)₃OH), or a mixture thereof. For complete dissolution, it may be dissolved in warmed water (e.g., about 60° C.) at a concentration of 5% to 30% to prepare an aqueous solution.

The pH adjusting agent may include sodium carbonate (Na₂CO₃), sodium hydroxide (NaOH), potassium hydroxide (KOH), calcium carbonate (CaCO₃), or a mixture thereof. For complete dissolution, it may be dissolved in warmed water (e.g., about 40° C.) at a concentration of 5% to 30% to prepare an aqueous solution.

The aqueous solution of the aluminum salt and the aqueous solution of the pH adjusting agent may be mixed at a constant rate (e.g., 25 ml/min) in the range of room temperature to 95° C. to perform a sol-gel reaction. The pH of the reactant may range from 6 to 10.

Through the above reaction, pseudo-boehmite with a chemical composition represented by AlO(OH) is produced as a solid as shown in Structural formula 1 below:

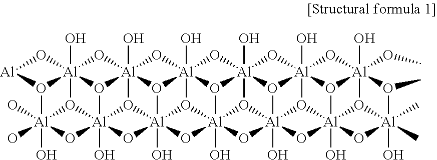

Pseudo-boehmite of the Structural formula 1 has water (H₂O) bonded to the octahedral unit cell, so it has a high water content and thus has a small crystallite size. Therefore, it can be formed under lower pH conditions than aluminum hydroxide (Al(OH)₃), which was mainly used as a starting material in the production of conventional alumina. At a later stage, when it is transformed into α-Al₂O₃ through a high-temperature calcinating process, particle agglomeration by seed and phase transition occur at a relatively low temperature, which is advantageous for obtaining a polyhedral crystal structure.

The pseudo-boehmite solids are filtered and washed, then mixed with a fluorine-based mineralizer and ultrapure water and pulverized (S2).

The fluoride-based mineralizer is an additive for growing crystals of α-alumina particles, and it includes LiF₂, AlF₃, NaF, NaPF₆, K₂TiF₆, MnF₂, or a mixture thereof.

When used in excessive amounts, such fluoride-based mineralizer may remain in the final α-alumina or form aggregates during the calcination process. In order to minimize such disadvantages, it is preferred to use the precursor powder and the fluoride-based mineralizer at a weight ratio of 100:0.1 to 100:2, specifically 100:0.5 to 100:1.5.

The ultrapure water is intended to increase pulverizing efficiency while promoting wet dispersion of pseudo-boehmite solids and fluoride-based mineralizers and may be used at a ratio of 1 to 10 times the weight of pseudo-boehmite. The wet dispersion promotes uniform dispersion of the fluoride-based mineralizer and minimizes agglomeration of precursor (pseudo-boehmite) particles, thereby affecting the polyhedral crystal structure of the final α-alumina particles.

The pulverization may be performed for 1 to 100 hours by milling using a plurality of balls having a diameter of 1 to 20 mm.

After filtering and drying the pulverized product, the obtained powder is calcined to obtain a powder of α-alumina particles having a nano-sized polyhedral crystal structure (S3).

The calcination which is a process of melt synthesis by heat treating dry powders at high temperature, may be performed in a crucible made of high purity alumina or zirconia.

Specifically, the calcination may be performed by raising the temperature at 3 to 15° C./min and maintaining the temperature of 800° C. to 1000° C. for 2 to 5 hours. The calcination condition can be appropriately changed considering the reaction and volatility due to differences in melting points of each material in the mixture and the amount of heat required for synthesis.

As described above, the nano-sized polyhedral α-alumina particles prepared as described above are coated while forming surface contact on the surface of the porous substrate, and the empty space induced by the interstitial volume between particles is formed larger than that of spherical particles, thereby being capable of achieving excellent air permeability while effectively suppressing thermal contraction of the porous polymer substrate.

Therefore, the present invention further provides a component comprising a porous polymer substrate and a coating layer formed on one or both sides of the substrate, wherein the coating layer includes α-alumina particles manufactured according to the present invention and having a polyhedral crystal structure and an average particle diameter (D₅₀) of 100 to 900 nm.

In one embodiment of the present invention, the component may include a separator for a secondary battery. The thickness of the porous polymer substrate included in the separator may range from 1 to 100 μm, the pore diameter present in the porous substrate may range from 10 to 100 nm, or 10 to 70 nm, or 10 to 50 nm, and the average particle diameter of the polyhedral alumina particles may be selected to be larger than the pore size of the porous substrate.

In addition, the coating layer may contain a binder to provide binding force of nano-sized polyhedral α-alumina to the surface of the substrate, and the binder may be selected from adhesive polyethylene, polypropylene, polyvinylidene fluoride, polyvinylidene fluoride-hexafluoropropylene, polystyrene, polyacrylic acid, and mixtures thereof. The thickness of the coating layer is not particularly limited, but may range from 0.5 to 50 μm or from 1 to 10 μm, considering the intended performance of the porous substrate.

The component having a coating layer comprising nano-sized polyhedral a-alumina particles may have 50% or more of a dimension retention rate as defined by Equation 1 below, in a thermal stability test using a circular specimen.

$$Dimension retention rate ( \% ) = {( {d}_{1} / {d}_{0} )}^{2} \qquad [ Equation 1 ]$$

wherein do is the diameter of the circular specimen before heat treatment, and d₁ is the diameter of the circular specimen after heat treatment at 150° C. for 30 minutes.

In addition, the component may satisfy an air permeability of 215 sec/100 cc or less, for example, 200 to 211 sec/100 cc, in the air permeability test measuring the time taken for 100 cc of air to permeate the circular specimen with a diameter of 1 inch.

### MODE FOR CARRYING OUT THE INVENTION

Hereinafter, the present invention will be described in detail through specific embodiments so that those skilled in the art can easily implement the present invention. However, the present invention may be implemented in many different forms and is not limited to the embodiments described herein.

### Example 1

### (Step 1)

An aqueous solution (a) in which 199.8 g of Al₂(SO₄)₃·14˜18H₂O was completely dissolved in 982.8 g of pure water heated to 60° C., and an aqueous solution (b) in which 95.4 g of Na₂CO₃ was completely dissolved in 528 g of pure water heated to 40° C. were prepared. The aqueous solution (b) was added to the aqueous solution (a) at a rate of 25 ml/min and stirred for 10 minutes to react. The reaction product (pH 7.3˜7.8) was filtered and washed to obtain pseudo-boehmite solids.

### (Step 2)

40 g of the pseudo-boehmite solids and 0.2 g of AlF₃ were mixed with 120 g of ultrapure water and pulverized by milling for 48 hours using balls with a diameter of 5 mm. Then, filtration and drying were performed.

### (Step 3)

The obtained product was filtered and dried, then heat-treated and calcined at 900° C. for 5 hours at a temperature increase of 10° C./min. After heat treatment, powder of α-alumina particles was finally obtained.

### Example 2

The same process as Example 1 was performed except that in step 2, pulverization by ball milling was performed for 24 hours.

### Comparative Example 1

The same process as Example 1 was performed except that ball milling was not performed in Step 2.

### Comparative Example 2

An aqueous solution (a) in which 199.8 g of Al₂(SO₄)₃·14˜18H₂O was completely dissolved in 982.8 g of pure water heated to 60° C., and an aqueous solution (b) in which 72 g of NaOH was completely dissolved in 528 g of pure water heated to 40° C. were prepared. The aqueous solution (b) was added to the aqueous solution (a) at a rate of 25 ml/min and stirred for 10 minutes to react. The reaction product (pH 7.3˜7.8) was filtered, washed, dried, and then pulverized to obtain pseudo-boehmite powders.

g of the pseudo-boehmite powders and 0.8 g of AlF₃ were mixed in a dry manner. The mixed powders were heat-treated and calcined at 900° C. for 5 hours at a temperature increase of 10° C./min. After heat treatment, powder of α-alumina particles was finally obtained.

The physical properties of the α-alumina particles prepared in Examples and Comparative Examples were measured and shown in Table 1 below.

TABLE 1

| | | Production condition | | | | | | |
|---|---|---|---|---|---|---|---|---|
| | | | | | | Pseudo- | Result | |
| | | | Ball | Pore | | boehmite:AlF₃ | Morphology | |
| | | Raw | milling | volume¹⁾ | Mixing | (weight | (crystallite | D₅₀²⁾ |
| | | material | time | (ml/g) | mode | ratio) | structure) | (μm) |
| Ex. | 1 | Pseudo- | 48 | 0.266 | Wet | 100:0.5 | Polyhedral | 0.25 |
| | 2 | boehmite | 24 | 0.291 | | 100:0.5 | Polyhedral | 0.52 |
| Comp. | 1 | Pseudo- | 0 | 0.332 | Wet | 100:0.5 | Polyhedral | 1.9 |
| Ex. | | boehmite | | | | | | |
| | 2 | Aluminum | 0 | 0.340 | Dry | 100:2.0 | Plate-like | 10.6 |
| | | hydroxide | | | | | | |

¹⁾Pore volume was measured using the gas adsorption method at the Korea Polymer Testing Laboratory.
²⁾D₅₀ was measured using an in-house particle distribution meter (CILAS 1090).

As can be seen in Table 1, the α-alumina particles prepared according to Examples by pulverizing pseudo-boehmite, wet mixing with a fluoride-based mineralizer, and then calcining had a nano-sized average diameter (D₅₀) and exhibited a polyhedral crystal structure with a ratio of D₅₀ and thickness close to 1.

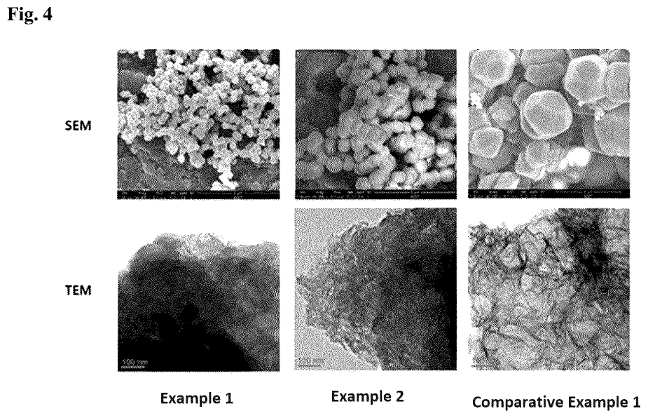

Meanwhile, SEM and TEM observation photos of the α-alumina particles prepared in Examples 1 and 2 and Comparative Example 1 are shown in FIG. 4.

From FIG. 4, it was found that the α-alumina particles of Examples 1 and 2 have a nano-sized 14-hedral crystal structure, and the α-alumina particles of Comparative Example 1 have a micro-sized 14-hedral crystal structure.

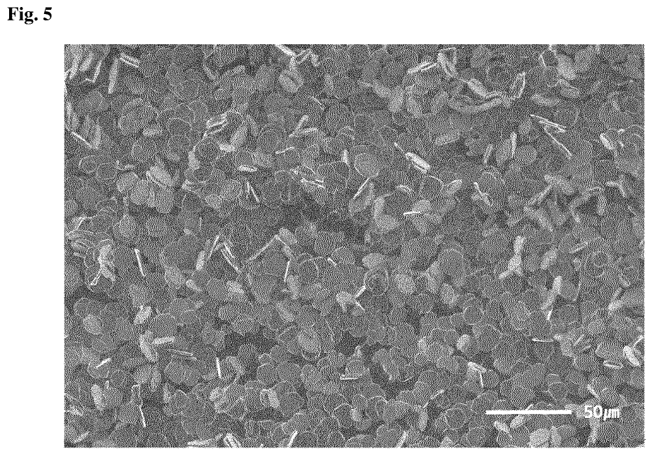

FIG. 5 is an SEM photograph of the α-alumina particles prepared in Comparative Example 2, showing the plate-like structure.

### Experimental Example 1: Air Permeability Test for Coating Secondary Battery Separator

A coating layer was formed on one side of the secondary battery separator using each of the α-alumina particles prepared in Examples and Comparative Examples. Specifically, the slurry obtained by dispersing α-alumina particles and acrylic polymer binder in water at a ratio of 95:5 was coated on one side of a polyethylene (PE) porous substrate (11 μm thick) and then dried to form a 2 μm thick coating layer.

The porous substrate on which the coating layer of α-alumina particles was formed was manufactured into a circular specimen with a diameter of 1 inch, and then the time taken for 100 cc of air to permeate through each specimen was measured using an air permeability measuring device (Asahi Seiko) (measurement condition: 25° C.). The results are shown in Table 2 below.

TABLE 2

| | Air permeability (sec/100 cc) |
|---|---|
| PE porous substrate | 150 |
| Example 1 | 211 |
| Example 2 | 203 |
| Comparative Example 1 | 185 |
| Comparative Example 2 | 323 |

From Table 2, it can be seen that the PE substrate coated with the nano-sized polyhedral α-alumina particles prepared in Examples 1 and 2 has excellent air permeability since the substrate has a shorter time for air to permeate compared to the substrate coated with plate-like alumina particles of Comparative Example 2.

On the other hand, the substrate coated with the alumina particles of Comparative Example 1 has excellent air permeability due to the micro particle size, but is disadvantageous in terms of thermal stability as shown in Experimental Example 2 below.

### Experimental Example 2: Thermal Stability Test for Coating Secondary Battery Separator

A thermal stability test according to particle size was performed on α-alumina particles with a polyhedral crystal structure that were confirmed to have excellent breathability in Experimental Example 1.

First, four types of polyhedral α-alumina particles with different particle sizes (100 nm, 250 nm, 500 nm, and 2 μm) and general spherical α-alumina particles (average particle diameter: 500˜700 nm) were prepared, and each type of particles was used to form a 2 μm thick coating layer on the PE porous substrate through the same process as in Experimental Example 1 to prepare a circular specimen with a diameter of 18 mm. The circular specimen was manufactured in triplicate for each of the coated alumina particles.

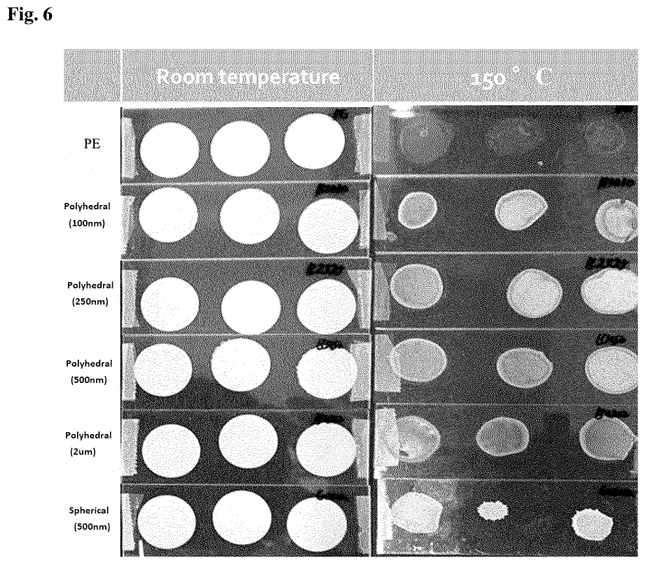

Each of the circular specimens was subjected to heat treatment at 150° C. for 30 minutes, and then the dimensional change was observed, and the results are shown in FIG. 6.

In addition, after heat treatment for each specimen, the dimension retention rate as defined by Equation 1 below was measured, and the results are shown in Table 3 below.

$$Dimension retention rate ( \% ) = {( {d}_{1} / {d}_{0} )}^{2} \qquad [ Equation 1 ]$$

wherein d₀ is the diameter of the circular specimen before heat treatment, and d₁ is the diameter of the circular specimen after heat treatment at 150° C. for 30 minutes.

TABLE 3

| | Dimension retention rate (%) | |
|---|---|---|
| | Room | After heat treatment |
| | temperature | at 150° C. |
| PE | 100 | 0 |
| Polyhedral particle (100 nm) | 100 | 52.1 |
| coating | | |
| Polyhedral particle (250 nm) | 100 | 66.6 |
| coating | | |
| Polyhedral particle (500 nm) | 100 | 60.5 |
| coating | | |
| Polyhedral particle (2 μm) coating | 100 | 57.9 |
| Spherical particle (500 nm) coating | 100 | 35.3 |

Referring to Table 3 and FIG. 6, it can be seen that polyhedral particles have superior thermal stability after being coated on a PE porous substrate compared to spherical particles.

Although embodiments according to the present invention have been described above, they are merely illustrative, and those skilled in the art will understand that various modifications and equivalent scope of embodiments are possible therefrom. Therefore, the true technical protection scope of the present invention should be determined by the following patent claims.

1. A coating composition comprising α-alumina particles having a polyhedral crystal structure and an average particle diameter (D₅₀) of 100 to 900 nm.

2. The coating composition according to claim 1, wherein the α-alumina particles have an average particle diameter (D₅₀) of 200 to 600 nm.

3. The coating composition according to claim 1, wherein the polyhedral crystal structure of the α-alumina particles includes a 14-hedral crystal structure.

4. The coating composition according to claim 1, wherein the ratio of planes in the polyhedral crystal structure of the α-alumina particles is 10 to 20% of the total crystal plane area.

5. A method for producing α-alumina particles contained in the coating composition of claim 1, the method comprising:
(S1) mixing and reacting an aqueous solution comprising one or more aluminum salts with an aqueous solution containing a pH adjusting agent, and filtering and washing the product to obtain pseudo-boehmite of the following structural formula 1;
(S2) mixing the pseudo-boehmite with a fluorine-based mineralizer and ultrapure water, and pulverizing the mixture, followed by filtering and drying; and
(S3) filtering and drying the product of step (S2) and then calcining it to obtain a powder of α-alumina particles having a polyhedral crystal structure and an average particle diameter (D₅₀) of 100 to 900 nm.

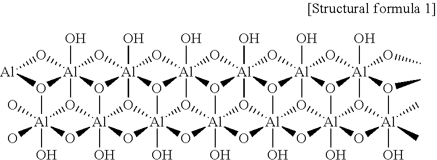

6. The method according to claim 5, wherein the aluminum salt used in step (S1) includes aluminum sulfate (Al₂(SO₄)₃·4˜18H₂O), aluminum nitrate (Al(NO₃)₃·9H₂O), aluminum acetate (Al(CHCOO)₃OH), or a mixture thereof.

7. The method according to claim 5, wherein the pH adjusting agent used in step (S1) includes sodium carbonate (Na₂CO₃), sodium hydroxide (NaOH), potassium hydroxide (KOH), calcium carbonate (CaCO₃), or a mixture thereof.

8. The method according to claim 5, wherein the ultrapure water in step (S2) is used at a ratio of 1 to 10 times the weight of pseudo-boehmite.

9. The method according to claim 5, wherein the pulverization in step (S2) is performed for 1 to 100 hours by milling using a plurality of balls having a diameter of 1 to 20 mm.

10. The method according to claim 5, wherein the pseudo-boehmite and the fluoride-based mineralizer in step (S2) are used in a weight ratio of 100:0.1 to 100:2.

11. The method according to claim 5, wherein the fluoride-based mineralizer includes LiF₂, AlF₃, NaF, NaPF₆, K₂TiF₆, MnF₂, or a mixture thereof.

12. The method according to claim 5, wherein the calcination in step (S3) is performed by raising the temperature at 3 to 15° C./min and maintaining the temperature of 800° C. to 1000° C. for 2 to 5 hours.

13. A component comprising a porous polymer substrate and a coating layer formed on one or both sides of the substrate,
wherein the coating layer includes the coating composition of claim 1.

14. The component according to claim 13, wherein the component includes a separator for a secondary battery.

15. The component according to claim 13, wherein the component has 50% or more of a dimension retention rate as defined by Equation 1 below, in a thermal stability test using a circular specimen
$$Dimension retention rate ( \% ) = {( {d}_{1} / {d}_{0} )}^{2} \qquad [ Equation 1 ]$$
wherein d₀ is the diameter of the circular specimen before heat treatment, and d₁ is the diameter of the circular specimen after heat treatment at 150° C. for 30 minutes.

16. The component according to claim 13, wherein the component exhibits an air permeability of 200 to 211 sec/100 cc, in the air permeability test measuring the time taken for 100 cc of air to permeate the circular specimen with a diameter of 1 inch.
